(19) United States
(12) Patent Application Publication
(10) Pub. No.: US 2006/0198920 A1
(43) Pub. Date: Sep. 7, 2006

(54) Unit for embossing a strip of wrapping material

(76) Inventors: Gilberto Spirito, Bologna (IT); Alessandro Minarelli, Bazzano (IT)

Correspondence Address: Harbin King & Klima, 500 Ninth Street SE, Washington, DC, 20003, US

(21) Appl. No.: 11/364,441

(22) Filed: Mar. 1, 2006

(30) Foreign Application Priority Data
Mar. 2, 2005 (IT) BO2005A000114

(51) Int. Cl. B28B 11/08

(52) U.S. Cl. 425/385

(57) ABSTRACT

Inner wrappers for packets of cigarettes are fashioned from a continuous strip of metal foil paper directed along a feed path internally of a cigarette packer, advancing through an embossing unit by which the metallic surface is textured, then through a rotary cutter such as will divide the material into leaves of specified length. The embossing unit is equipped with an assembly comprising a pair of rollers, also with a stabilizing mechanism that utilizes an aspirating roller to induce a controlled plastic deformation in the strip, canceling out the random deformations induced by the embossing action, and, with each revolution of the cutter, simultaneously advancing a portion of the embossed strip equivalent to the length of one leaf.

### BACKGROUND OF THE INVENTION

The present invention relates to a unit for embossing a strip of wrapping material.

In particular, the present invention relates to a unit serving to emboss a continuous strip of material, typically metal foil paper, that will be divided up ultimately into discrete lengths and fed to the wrapping mechanisms of a cigarette packer.

In cigarette packers of conventional design, a strip of metal foil paper is drawn from a roll by decoiling means, directed along a predetermined feed path, taken up by cutting means and divided into single leaves each destined to envelop a group of cigarettes and thus provide an inner wrapper for a respective packet.

At a given point upstream of the cutting means, likewise conventionally, the strip of material is subjected to the action of an embossing unit consisting in two rollers placed on opposite sides of the aforementioned feed path and contrarotating tangentially one relative to another.

The two rollers are linked mechanically to the cutting means and present cylindrical surfaces with projections, generally of frustopyramidal shape, such as will indent the metallic strip passing between the rollers and cause it to assume the characteristic roughened texture adopted for inner foil wrappers.

The cylindrical surface of each embossing roller, of which the circumferential measurement is equal substantially to the length of one leaf cut from the continuous strip, can present areas devoid of the aforementioned frustopyramidal projections, such as will combine to make up the letters of a word, “PULL”, or a selected graphic symbol.

Accordingly, the “PULL” mark (or selected graphic symbol) is created by leaving areas of the surface unembossed and will appear on each leaf of the cut strip, placed to coincide with a portion of the inner wrapper destined to be removed at the moment of opening the packet of cigarettes.

Before the packer is set in motion, an operator adjusts the positioning of the strip relative to the cutting means, so that the “PULL” mark will be correctly located on each leaf and therefore on the inner wrapper of the finished packet.

In practice, it has been found that the embossing step is a direct cause of certain drawbacks.

More particularly, it has been observed that when subjected to the action of the embossing unit, which results in plastic deformation, the strip of wrapping material tends to behave in an entirely unpredictable manner due to a number of different factors: environmental (temperature and humidity), physical (quality of the material), and mechanical (in particular, the tension to which the strip is subject when passing through the embossing unit).

As a consequence of the plastic deformation in question, which is also the cause of microslippage induced in the strip relative to the embossing rollers, and the above noted fact that the cutting means are linked mechanically to the embossing unit, the length of the leaves separated from the strip becomes irregular and will in general differ randomly from the correct value.

This variation in length also results in a loss of timing, with the “PULL” mark shifting from its correct position on the leaf and therefore on the inner wrapper of the finished packet.

The object of the present invention is to provide a unit for embossing a strip of wrapping material, from which the drawbacks mentioned above will be absent.

### SUMMARY OF THE INVENTION

The stated object is realized in a unit according to the present invention for embossing a strip of wrapping material, which comprises a pair of embossing rollers positioned along a set feed path followed by the strip and establishing an embossing station, and incorporates means, positioned along the feed path, by which the strip is deformed plastically or stretched.

### BRIEF DESCRIPTION OF THE DRAWINGS

The invention will now be described in detail, by way of example, with the aid of the accompanying drawings, in which:

FIG. 1 illustrates an infeed portion of a cigarette packer, equipped with an embossing unit according to the present invention, viewed schematically and frontally in elevation and shown in a first embodiment;

FIGS. 2 and 3 show a detail of FIG. 1, viewed in perspective;

FIG. 4, 5 and 6 show three further embodiments of the unit according to the present invention, viewed schematically and frontally in elevation;

FIG. 7 illustrates equipment for rewinding a strip of wrapping material, viewed frontally in elevation and equipped with an embossing unit according to the present invention.

### DESCRIPTION OF THE PREFERRED EMBODIMENTS

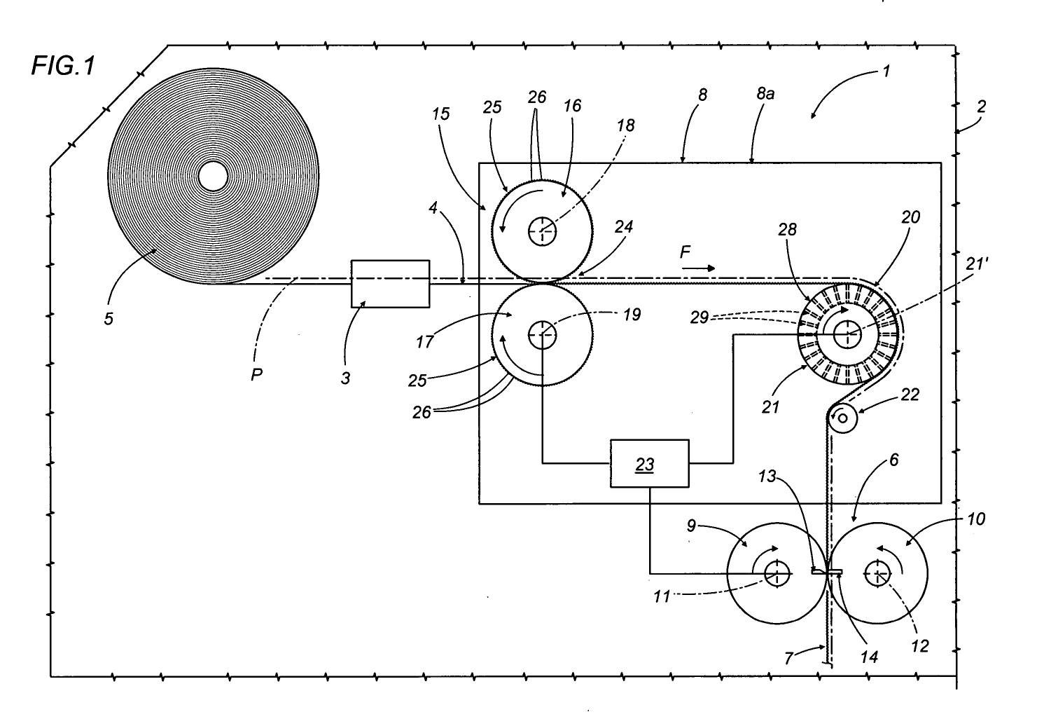

With reference to FIG. 1, numeral 1 denotes the infeed portion, in its entirety, of a cigarette packer incorporating a frame of which a frontal bulkhead 2 is illustrated.

The infeed portion 1 comprises means, mounted to the bulkhead 2 and illustrated schematically as a block, denoted 3, serving to guide and feed a continuous strip 4 of metal foil paper 4 decoiled from a roll 5, also cutter means 6 by which the strip 4 is divided into single leaves 7 destined to provide inner wrappers, fashioned through the agency of wrapping means (not illustrated), for cigarette packets.

Interposed between the guide and feed means 3 and the cutter means 6 is an embossing unit, denoted 8 in its entirety, mounted to a substantially rectangular vertical plate 8a carried by the bulkhead 2.

The embossing unit 8 combines with the guide and feed means 3 and the cutter means 6 to establish a feed path P along which the strip 4 advances in the direction indicated by the arrow denoted F.

The cutter means 6 comprise two contrarotating rollers 9 and 10, turning on respective horizontal axes 11 and 12 disposed transversely to the feed path P, equipped respectively with a blade 13 and with an anvil 14.

The embossing unit 8 comprises an embossing assembly 15 that consists of two contrarotating rollers 16 and 17 turning on respective axes 18 and 19 extending parallel to the axes 11 and 12 of the cutter rollers, and, at a given point downstream of the assembly 15 (in the direction of the arrow F), tension means 20 by which the advancing strip 4 is deformed plastically in the longitudinal direction, or stretched, composed of a decoiling roller 21 turning clockwise on an axis 21′ parallel to the axes 18 and 19 of the embossing rollers, and an idle diverter roller 22 located below the decoiling roller 21.

The blade roller 9 of the cutter means 6 is coupled directly to the anvil roller 10 and driven by a motor indicated schematically as a block 23.

Similarly, one embossing roller 17 is coupled directly to the other embossing roller 16 and driven by the aforementioned motor 23, which also drives the decoiling roller 21.

With each single operating cycle of the embossing unit 8, which corresponds to one full rotation of the cutter rollers 9 and 10, the blade 13 and the anvil 14 strike together on the line of the feed path P and separate a leaf 7 of predetermined length L from the strip 4, destined to form the inner wrapper of a packet of cigarettes.

The two embossing rollers 16 and 17 are of circumferential length substantially equivalent to the linear length of one leaf 7, or to a multiple thereof, and positioned mutually tangential at an embossing station 24; both rollers 16 and 17 present cylindrical surfaces 25 covered by frustopyramidal projections 26 such as will impress the strip 4 with the familiar rough or reeded texture of an inner foil wrapper as it passes through the embossing station 24.

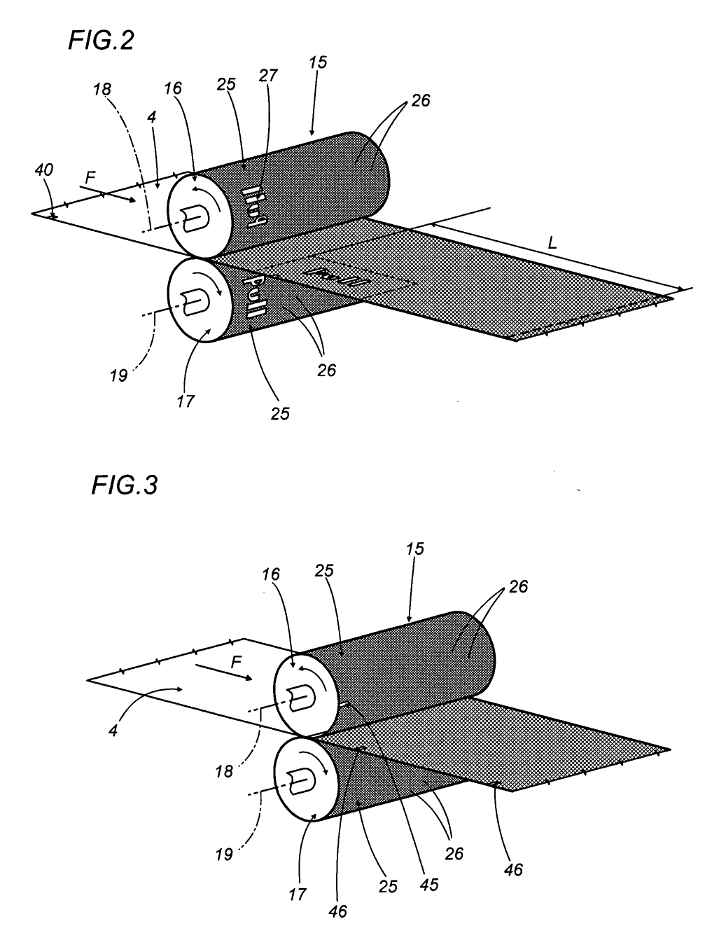

As illustrated in FIG. 2, the cylindrical surfaces 25 of the embossing rollers 16 and 17 will present areas 27 devoid of the aforementioned frustopyramidal projections 26 and reproducing the word “PULL” (or a selected graphic symbol having the same significance).

Accordingly, this same mark, created by virtue of the area remaining unembossed, will appear on each of the leaves 7 and therefore on the inner wrapper of each packet of cigarettes, positioned so as to be visible on opening the packet.

Once beyond the embossing rollers 16 and 17, the strip 4 passes through an arc substantially of 180° around the cylindrical surface 28 of the decoiling roller 21, which is furnished with a plurality of holes 29 connected to a source of negative pressure (not illustrated), thence around the idle diverter roller 22 and toward the cutter means 6.

The circumference of the decoiling roller 21 is marginally greater than the circumference of the embossing rollers 16 and 17.

Passing through the embossing station 24, the strip 4 undergoes a plastic deformation such that, with each cycle completed by the two rollers 16 and 17, the length of the embossed portion of strip emerging from the assembly 15 is dissimilar (generally less, but sometimes greater) to that of the unembossed portion entering the assembly.

This variance or error can vary unpredictably over time, dependent as it is on a multiplicity of factors, for example ambient temperature and humidity, the quality of the material used for the strip 4, the degree of slippage between the strip 4 and the rollers 16 and 17 induced at the embossing station 24, and the tensile force to which the strip 4 is subject.

Given that the decoiling roller 21 rotates at a tangential velocity marginally greater than that of the embossing rollers 16 and 17, due to its greater circumference, and that the embossed strip 4 clings to the cylindrical surface 28 without slipping, the advancing strip 4 will be subjected, along the stretch between the embossing station 24 and the cylindrical surface 28, to a tensile force by which it is deformed plastically in a direction opposite to the force applied by the embossing rollers 16 and 17, but in a perfectly controlled manner.

Accordingly, the random deformations induced by the embossing step are cancelled out and, where the circumference of the decoiling roller 21 happens to coincide with the predetermined length L mentioned above, the portions of embossed strip 4 fed cyclically to the cutter means 6, and ultimately the leaves 7 separated with each cycle of the selfsame cutter means 6, will be of length that remains constant over time and equal to the predetermined length L (see FIG. 2).

Thus, the tension means 20 provide means (also denoted 20) by which to stabilize the length of the portions of embossed strip directed cyclically from the embossing assembly 15 to the cutter means 6.

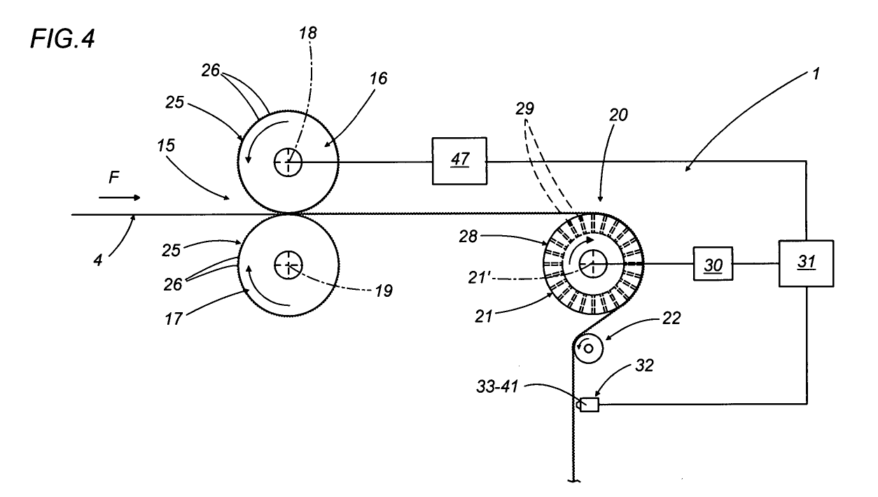

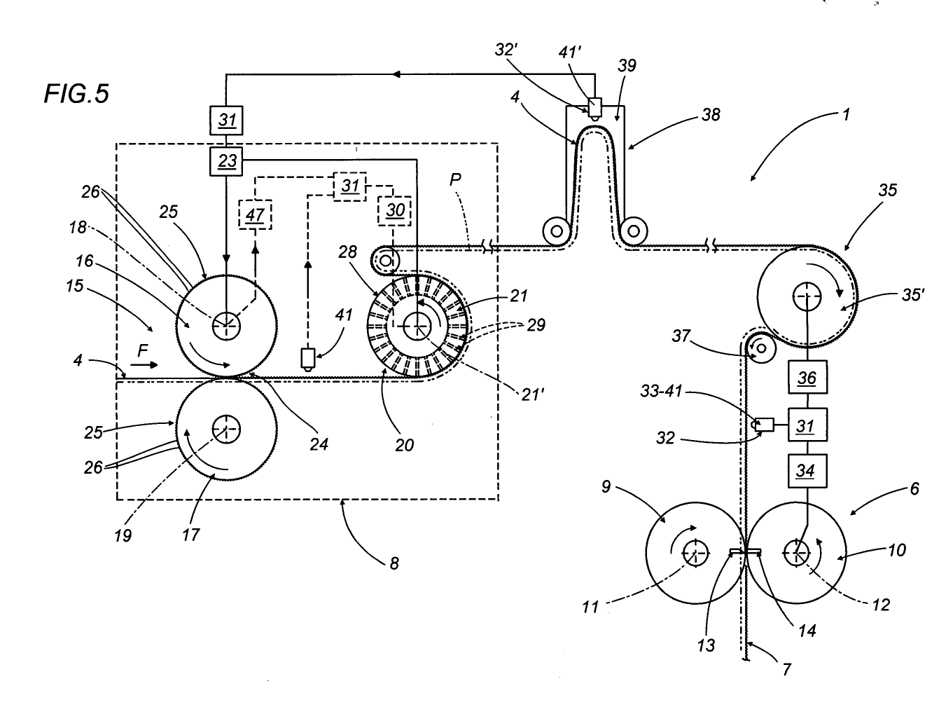

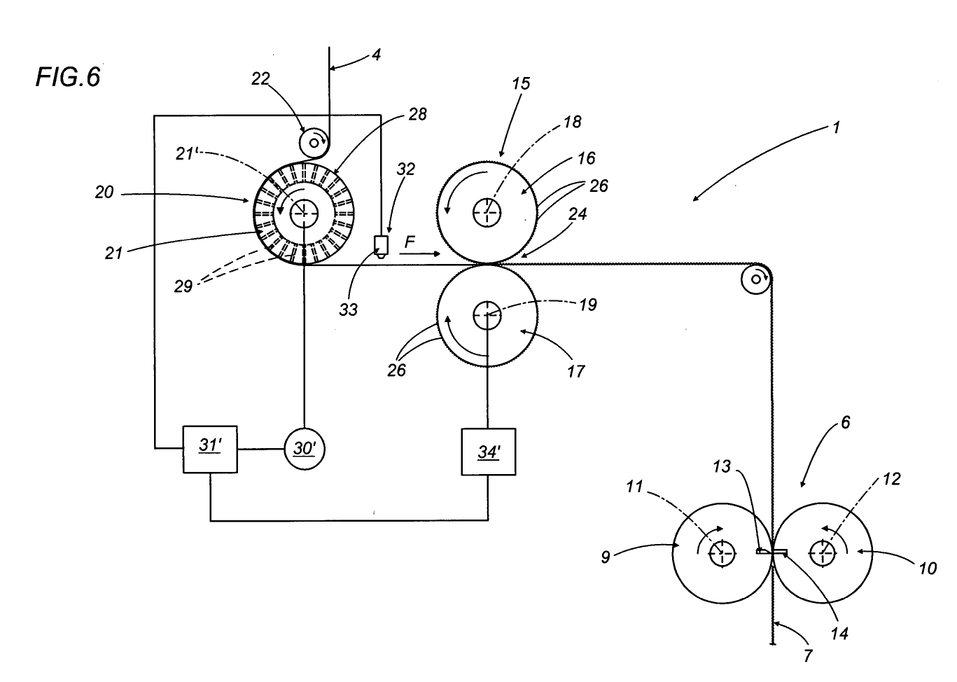

FIG. 4 illustrates an embodiment of the unit differing from that described above in that the decoiling roller 21 is driven by an independent variable speed motor 30, of which the operation is interlocked to a control circuit block denoted 31.

Where the strip 4 of wrapping material happens to be a preprinted type, for example procured from a paper mill and bearing printed images or logos, errors may occur in the positioning of the “PULL” mark relative to the images or logos.

Such positioning errors could be occasioned by the aforementioned microslippages induced at the embossing station 24, and/or by irregular spacing between the preprinted images, and/or by the elasticity of the material used for the strip 4.

In this instance, observing FIG. 4, a first input of the control circuit block 31 can be connected to means 32 capable of sensing the position of the images and/or the logo, typically a TV camera 33, and a second input to means 47 that will emit a cyclical timing signal referenced to the embossing roller 16.

Thus, by controlling the speed of the decoiling roller 21, the position of the preprinted images and/or logos relative to the “PULL” mark impressed by the embossing rollers 16 and 17 can be correctly adjusted and maintained steady over time.

In addition, it will be seen that the independent drive system also serves, in conjunction with the facility of controlling the tangential velocity of the decoiling roller 21 and with the feedback from the sensing means 32, to give exact and continuous control over the position of the “PULL” mark on each length of strip corresponding ultimately to a single leaf 7. In this instance, clearly enough, the circumferential dimensions of the decoiling roller 21 are not critical in determining the length L of the leaf 7.

The embodiment of FIG. 5 differs from that of FIG. 1 in that the infeed portion 1 is equipped further with a feed unit 35, interposed between the tension means 20 and the cutter means 6, comprising a first roller 35′ power driven by a variable speed independent motor 36, and an idle roller 37 by which the strip 4 is diverted directly into the cutter means 6.

Whilst the decoiling roller 21 serves to stabilize the length of the portions of embossed strip directed cyclically along the feed path P, as in the examples already illustrated, the function of the variable speed roller 35′ is to combine with the means illustrated in FIG. 4 (control circuit block 31, sensing means 32 and signal emitter means 34) in maintaining correct synchronization between the position of the “PULL” mark and the stroke of the cutter means 6.

Passing from the decoiling roller 21 to the feed unit 35, the strip 4 is directed through a storage buffer 38 of the type comprising a negatively pressurized chamber 39 internally of which the running strip 4 forms a loop of variable length.

The inclusion of the buffer 38, which itself is of familiar embodiment, facilitates the adjustment and control operations described above by ensuring the strip 4 will run neither tight nor slack.

With this precise end in view, the buffer 38 is equipped with relative sensing means 32′, typically a photocell 41′, such as will detect the level of the strip 4 internally of the chamber 39.

The sensing means 32′ are connected on the output side to a relative control circuit block 31, to which the motor 23 driving the embossing roller 16 and the decoiling roller 23 is also interlocked.

In this situation, the operation of the motor 23 can be piloted by the embossing unit 8 in response to signals received from the photocell 41′, in such a way as will maintain the loop of strip 4 at a constant and predetermined level internally of the buffer 38.

Likewise in this embodiment, the unit according to the invention can include a control circuit block 31 as in the example of FIG. 4, of which a first input is connected to a TV camera 33 capable of sensing the position of the images and/or logos on the strip 4, and a second input to means 47 that will emit a cyclical timing signal referenced to the embossing roller 16.

Accordingly, and in like manner to the example of FIG. 4, by controlling the speed of the decoiling roller 21, the positioning of the images and/or logos preprinted on the strip 4 can be adjusted and held steady relative to the “PULL” mark impressed with the embossing rollers 16 and 17.

Finally, it will be appreciated that in the example of FIG. 5, the decoiling roller 21 can be equipped with an independent motor 30, rather than being driven by the same motor 23 as the embossing roller 16.

Referring again to FIG. 2, it will be seen that the word “PULL” impressed by the embossing rollers might be replaced by a reference mark 40 in the guise of a preprinted stripe or dash, that is to say a mark made on the strip by a printing device at intervals corresponding to the length of the single leaves 7, before the strip itself is wound onto the roll 5.

Where printed reference marks 40 are used, the sensing means 32 illustrated in the examples of FIGS. 4 and 5 could take the form of photocells 41 instead of TV cameras 33.

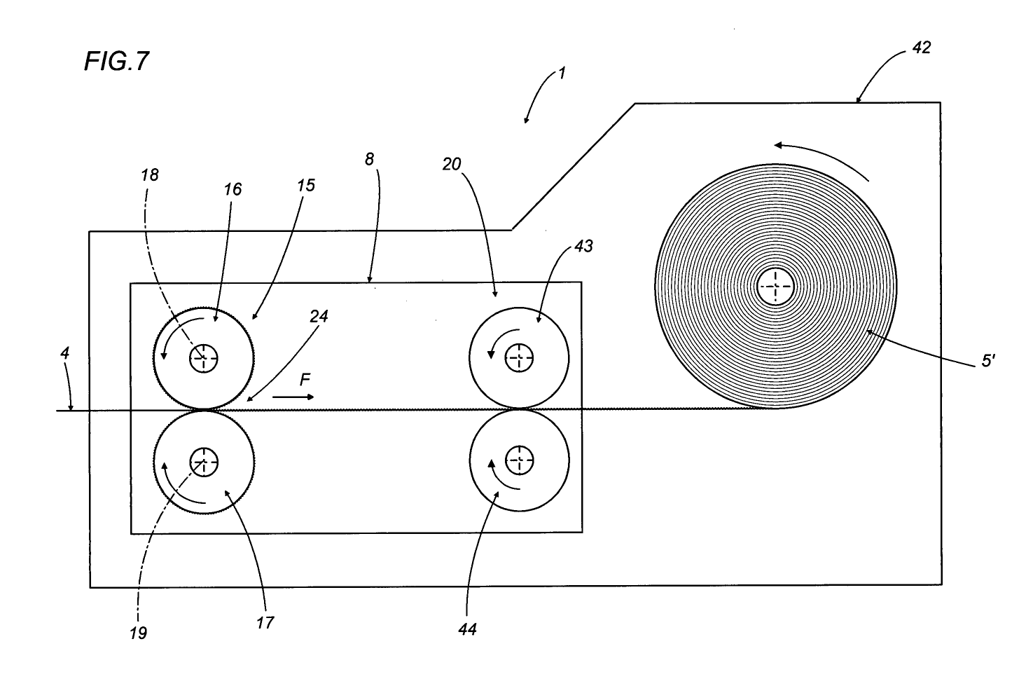

In the example of FIG. 7, the embossing unit 8 forms part of equipment 42 by which the embossed strip 4 is rewound onto a roll 5′.

Instead of the aspirating roller 21, tension means 20 serving to stabilize the strip 4 might consist in a pair of rollers 43 and 44 set in contrarotation substantially tangential one to the other, such as will decoil one length L of embossed strip with each cycle of rotation.

In a further embodiment of the unit, illustrated in FIG. 3, the cylindrical surface 25 of at least one embossing roller 16 or 17 (that denoted 16 in FIG. 3) presents an area, for example rectangular or circular in shape, devoid of frustopyramidal projections 10 and functioning as a die 45.

The sole function of the die 45 is to impress a succession of cyclical reference marks 46 on the strip 4 such as can be used to effect a positional adjustment, relative to the cutter means 6, more accurate than that obtainable using the “PULL” mark and more reliable than that obtainable using a strip 4 with preprinted marks 40.

The reference marks 46, impressed on the leaves 7 in such a way as to remain invisible when the packet is opened, are detectable by means of the photocell 41.

In the example of FIG. 6, the tension means 20 are located upstream of the embossing assembly 15. The aspirating decoil roller 21 is driven by an independent variable speed motor 30′ interlocked in operation to a control circuit block 31′.

A first input of the control circuit block 31′ is connected to sensing means 32, located between the decoiling roller 21 and the embossing assembly 15 and consisting in a photocell 33 able to detect the position of preprinted marks 40 on the strip 4. A second input of the circuit block 31′ is connected to means 34′ such as will emit a cyclical timing signal referenced to the embossing roller 17.

With this arrangement, it becomes possible to control the positioning of the preprinted marks 40 relative to the embossing rollers 16 and 17.

Finally, numeral 48 denotes a diverting roller located downstream of the embossing assembly 15, by which the embossed strip 4 is directed toward the cutter means 6.

1. A unit for embossing a strip of wrapping material separable into leaves for use by the wrapping equipment of a packer machine, comprising:
a pair of embossing rollers positioned along a predetermined feed path followed by the strip and establishing an embossing station;
means, positioned along the feed path, by which the strip is deformed plastically or stretched.

2. An embossing unit as in claim 1, wherein plastic deformation means consist in means by which to stabilize the length measurement presented by portions of embossed strip constituting the leaves.

3. An embossing unit as in claim 2, wherein the stabilizing means are located downstream of the embossing station.

4. An embossing unit as in claim 1, wherein stabilizing means comprise rotary decoiling means by which a portion of the strip presenting a predetermined length is advanced with each operating cycle.

5. An embossing unit as in claim 4, wherein decoiling means comprise an aspirating decoil roller such as will prevent slippage between the strip and the cylindrical surface of the selfsame roller.

6. An embossing unit as in claim 4, wherein decoiling means comprise two contrarotating rollers substantially tangential one to another.

7. An embossing unit as in claim 6, wherein the decoiling means rotate at a tangential velocity marginally greater than that of the embossing rollers, in such a way that the strip is subjected to a tensile force along the portion of the feed path extending between the embossing station and the selfsame decoiling means.

8. An embossing unit as in claim 7, wherein the decoiling rollers are set in motion by variable speed drive means interlocked in operation to means capable of sensing images and/or logos printed previously on the strip.

9. An embossing unit as in claim 4, comprising a variable speed feed unit installed downstream of the decoiling means, interlocked in operation to means capable of sensing reference marks located on the strip at intervals of predetermined length.

10. An embossing unit as in claim 9, wherein the reference marks consist in lettering or an equivalent graphic symbol identifying a removable portion of each leaf, and sensing means consist in a TV camera.

11. An embossing unit as in claim 9, wherein the reference marks consist in stripes or dashes printed previously on the strip.

12. An embossing unit as in claim 9, wherein the reference marks consist in impressions made on the strip by the embossing rollers.

13. An embossing unit as in claim 11, wherein sensing means consist in a photocell.

14. An embossing unit as in claim 9, comprising a storage buffer occupiable by the advancing strip, located along the portion of the feed path interposed between the decoiling means and the feed unit.

15. An embossing unit as in claim 14, further comprising means associated with the storage buffer and serving to monitor the level of the strip internally of the buffer, such as will supply an output signal to a relative control circuit block piloting the operation of the motor driving the embossing assembly and the decoiling roller.

16. An embossing unit as in claim 5, wherein the stabilizing means, provided by the decoiling roller, are positioned upstream of the embossing station.

17. An embossing unit as in claim 16, wherein the decoiling roller is set in rotation by variable speed drive means interlocked in operation to means capable of sensing preprinted reference marks on the strip.

18. A cigarette packer, equipped with an embossing unit as in claim.

19. Equipment for rewinding an embossed strip onto a roll, comprising an embossing unit as in claim 1.

20. A unit for embossing a strip of wrapping material separable into leaves for use by the wrapping equipment of a packer machine, comprising a pair of embossing rollers positioned along a predetermined feed path followed by the strip and establishing an embossing station, wherein the cylindrical surface of at least one of the two embossing rollers comprises at least one die such as will impress reference marks cyclically on the strip.

21. An embossed strip of wrapping material, obtainable by means of an embossing unit as in claim 1.
